(19) United States
(12) Patent Application Publication
(10) Pub. No.: US 2024/0120741 A1
(43) Pub. Date: Apr. 11, 2024

(54) MODULAR BATTERY STORAGE SYSTEM WITH RECHARGEABLE ENERGY STORAGE MODULES, AND METHOD FOR OPERATING THE BATTERY STORAGE SYSTEM

(71) Applicant: VARTA Microbattery GmbH, EIIwangen Jagst (DE)

(72) Inventor: Dieter KLOOS, Fichtenau (DE)

(21) Appl. No.: 18/275,441

(22) PCT Filed: Dec. 16, 2021
(86) PCT No.: PCT/EP2021/086206

§ 371 Date: Aug. 2, 2023

(30) Foreign Application Priority Data
Feb. 4, 2021 (EP) 21155140.3

(51) Int. Cl. H02J 3/32; B60L 53/53; H01M 10/42; H01M 10/44; H01M 50/204; H01M 50/258; H02J 7/00

(52) U.S. Cl. CPC H02J 3/32; B60L 53/53; H01M 10/425; H01M 10/441; H01M 50/204; H01M 50/258; H02J 7/0013; H02J 7/00711; H02J 2207/20

(57) ABSTRACT

A modular battery storage system includes an array of n rechargeable energy storage modules. Each respective energy storage module is assigned a respective switch via which the respective energy storage module can be activated and deactivated. The n rechargeable energy storage modules are configured to be interconnected, via the switches, such that a total voltage U_{Total} provided by the array of n rechargeable energy storage modules is a sum of respective individual voltages U_{single} of activated energy storage modules. The modular battery storage system further includes a controller, configured to control the switches, and a modulator, connected to the n rechargeable energy storage modules and configured to modulate the total voltage U_{Total}. The modulator includes a pulse width modulation switch. A housing encloses the pulse width modulation switch and is adapted to shield electronic components outside the housing from electromagnetic interference radiation emanating from the pulse width modulation switch.

### CROSS REFERENCE TO RELATED APPLICATIONS

This application is a U.S. National Phase application under 35 U.S.C. § 371 of International Application No. PCT/EP2021/086206, filed on Dec. 16, 2021, and claims benefit to European Patent Application No. EP 21155140.3, filed on Feb. 4, 2021. The International Application was published in German on Aug. 11, 2022 as WO 2022/167136 under PCT Article 21(2).

### FIELD

The present disclosure relates to a modular battery storage system comprising an array of n rechargeable energy storage modules and a method for operating such a modular battery storage system.

### BACKGROUND

A modular battery storage system comprises an array of n energy storage modules, wherein n is at least 2. The energy storage modules are designed to be rechargeable. Within a battery storage system, the energy storage modules are generally connected by parallel and/or serial interconnection. The energy storage modules can comprise individual electrochemical cells or assemblies of two or more such cells. Within such an assembly, individual electrochemical cells can in turn be connected by parallel and/or serial interconnection.

Such battery storage systems are mostly used as a direct current source. However, with the help of a multilevel converter, battery storage systems can also be connected to an AC grid. In such converters, the voltages of individual energy storage modules are added with a time delay for different periods of time. If the voltages of the individual energy storage modules are sufficiently small in relation to the added total voltage, sinusoidal voltage characteristics, for example, can be generated to a good approximation.

WO 2018/162122 A1 describes a modular battery storage system in which the individual energy storage modules are each assigned a switch via which the respective energy storage module can be activated and deactivated. The energy storage modules can be interconnected in such a way that the individual voltages of activated energy storage modules can add up to a total voltage. In this case, at least one performance value is determined for each of the energy storage modules and a time-varying total voltage is generated by activating at least two energy storage modules overlapping in time but over activation periods of different lengths. Depending on the respective performance value, activation periods of different lengths are assigned to the individual energy storage modules so that energy storage modules of various types can also be well integrated into the system.

In such modular battery storage systems, the total voltage can be gradually elevated and depressed by successively connecting the energy storage modules so that a so-called staircase voltage, which approximates a sinusoidal half-wave, can be generated. In principle, any curve shape can be generated by appropriately switching the individual energy storage modules on and off at the right times.

However, only a rough approximation of the desired output voltage is possible by switching the energy storage modules on and off or activating and deactivating them. For further approximation of the stepped voltage, which is achievable by suitable switching of the energy storage modules, it is therefore already known to perform pulse width modulation (PWM) on the individual voltages generated. For example, the aforementioned WO 2018/162122 A1 already describes that each switch assigned to the individual energy storage modules is designed to perform such pulse-width modulation. The individual voltages modified in this way can then be added up to a total voltage, which is thus further approximated to the desired sinusoidal wave of the voltage.

High frequencies are generally required to perform pulse width modulation. However, this results in the problem that the high frequencies have a detrimental effect on electromagnetic compatibility (EMC) and complex shielding measures become necessary. Under certain circumstances, however, these problems cannot be solved even with elaborate shielding measures, so that overall the functionality and possible applications of battery storage systems are severely limited in practice. The heating associated with high frequencies also makes it necessary to cool the individual energy storage modules.

WO 2018/162122 A1 already suggests that, if necessary, only one of the switches assigned to the energy storage modules is designed for PWM generation. Nevertheless, this does not provide a satisfactory solution to the problems that arise in battery storage systems of this type, particularly with regard to electromagnetic interference.

### SUMMARY

In an embodiment, the present disclosure provides a modular battery storage system. The modular battery storage system includes an array of n rechargeable energy storage modules, each respective rechargeable energy storage module of the n rechargeable energy storage modules comprising at least one rechargeable energy storage element. Each respective energy storage module is assigned a respective switch via which the respective energy storage module can be activated and deactivated. The n rechargeable energy storage modules are configured to be interconnected, via the switches, such that a total voltage U_{Total} provided by the array of n rechargeable energy storage modules is a sum of respective individual voltages U_{single} of activated energy storage modules. The modular battery storage system further includes a controller, configured to control the switches, and a modulator, connected to the n rechargeable energy storage modules and configured to modulate the total voltage U_{Total}. The modulator includes a pulse width modulation switch. A housing encloses the pulse width modulation switch and is adapted to shield electronic components outside the housing from electromagnetic interference radiation emanating from the pulse width modulation switch.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a total voltage curve of a modular battery storage system;

FIG. 2 illustrates a prior art modular battery storage system;

FIG. 3 illustrates a modular battery storage system according to an embodiment; and

FIG. 4 illustrates a structure of a modulator as part of a modular battery storage system according to an embodiment.

### DETAILED DESCRIPTION

The present disclosure provides an improved modular battery storage system which, on the one hand, offers a cost-effective solution and, on the other hand, is very robust in operation and not susceptible to faults. In particular, the battery storage system should be able to feed the voltage generated by the individual energy storage modules into an AC grid.

The present disclosure provides a modular battery storage system and a method for operating such a modular battery storage system. Preferred embodiments of the modular battery storage system and of the method for operating this battery storage system are described herein.

The modular battery storage system comprises an array of n rechargeable energy storage modules. In this context, the modular battery storage system includes the following features:
a. The n energy storage modules each comprise at least one, preferably several rechargeable energy storage elements, and
b. each individual one of the n energy storage modules is assigned a switch via which the respective energy storage module can be activated and deactivated, and
c. the n energy storage modules can be interconnected via the switches in such a way that the individual voltages U_{single} of activated energy storage modules can add up to a total voltage U_{Total}, and
d. the battery storage system comprises a control device for controlling the switches associated with the n energy storage modules.

According to the present disclosure, the modular battery storage system comprises a modulation unit (feature e.), which is characterized by the following features i. to iii:
i. The modulation unit is connected to the connectable n energy storage modules in such a way that it is capable to modulate the total voltage U_{Total},
ii. the modulation unit comprises a pulse width modulation switch, and
iii. the modulation unit comprises a housing which encloses the pulse width modulation switch and which is adapted to shield electronic components outside the housing from electromagnetic interference radiation emanating from the pulse width modulation switch.

Switches for pulse width modulation are prior art and are commercially available. According to the present disclosure, the modular battery storage system is characterized by at least one of the immediately following additional features a. to c.:
a. The pulse width modulation switch comprises a plurality of semiconductor switches.
b. The pulse width modulation switch comprises an H-bridge circuit with four semiconductor switches.
c. The H-bridge circuit comprises two line branches, each with two semiconductor switches connected via a capacitor.

Preferably, the immediately preceding features a. to c. are realized in combination.

The semiconductor switches are preferably MOSFETs. As an alternative to these, however, bipolar transistors, in particular bipolar transistors with insulated gate electrodes (IGBTs), can also be used as semiconductor switching elements.

In further preferred embodiments, the modular battery storage system has at least one of the immediately following additional features a. and b:
a. The modulation unit comprises a filter choke connected downstream of the pulse width modulation switch in the discharge direction.
b. The housing also encloses the filter choke.

Preferably, the immediately preceding features a. and b. are realized in combination.

By activating and deactivating individual energy storage modules, the battery storage system described herein is able to generate a step-shaped total voltage which is converted by the modulation unit and the pulse width modulation switch contained therein into an overall pulse width modulated voltage curve which is very close to the desired voltage curve. Pulse width modulation (PWM) cushions the transitions between individual voltage stages. The voltage waveform is further smoothed by means of the downstream filter choke, so that the desired waveform is generated. This makes it possible, for example, to convert the DC voltage generated by the individual energy storage modules into a sinusoidal waveform in a particularly advantageous manner, wherein this voltage can be fed into an AC grid.

The particular advantage of the battery storage system described herein is that the PWM is carried out at a central point in the modulation unit, into which the added individual voltages are fed. The modulation unit thereby combines the pulse width modulation switch with the downstream filter choke, which enables the smoothing of the curve and thus its feeding into the grid, wherein this modulation unit as a whole is shielded by a suitable housing, in particular a metallic housing, in such a way that electromagnetic interference radiation generated during this process is reliably intercepted and does not penetrate to the outside. The housing of the modulation unit preferably encloses both the pulse width modulation switch and the filter choke.

In some preferred embodiments, the control device is also located within the housing.

The PWM at a central location avoids the need to perform such pulse width modulation in the individual energy storage modules, which is fraught with various problems. In particular, this avoids generating decentralized electromagnetic interference. The requirement for electromagnetic shielding is therefore limited to the modulation unit, so that all the other components of the battery storage system can be designed to be much simpler and less expensive.

The central implementation of PWM in the modulation unit of the modular battery storage system is connected with considerable cost advantages. If, for example, a PWM were to be provided in each individual energy storage module or in the associated switch, as in the prior art, considerable costs would have to be incurred due to the fast switching elements and the fast and powerful drivers required for this purpose. In the modular battery storage system described herein, on the other hand, the individual energy storage modules can be designed in a much simpler manner, since the associated switches need only allow the energy storage module to be switched on and off or activated and deactivated. Low-cost switches operated at a comparatively low clock frequency can be used for this purpose.

The high frequencies required with a PWM in the individual energy storage modules of conventional systems are also associated with large-scale heat generation in the periphery of the system in conventional modular battery storage systems, which must be regulated by appropriate cooling systems. This can also be dispensed with in the modular battery storage system described herein, wherein at most cooling of the modulation unit is required. This is also connected with a considerable cost advantage.

In a conventional modular battery storage system with a PWM in the switches of the individual energy storage modules, considerable interference can be observed as a result of the PWM clocking in the extensive wiring of such battery storage systems due to the pulsating electromagnetic fields, which on the one hand can have a disturbing effect on the functionality of the system itself and on the other hand must also be shielded from the outside in order to be able to comply with specifications for electromagnetic compatibility. Such shielding poses major problems, especially due to the extensive space requirements of such systems, which are almost completely avoided in the modular battery storage system described herein, since in principle only the modulation unit has to be electromagnetically shielded.

The control of the correct PWM ratio at exactly the right time for the respective energy storage module, which is required in conventional modular battery storage systems with a PWM circuit assigned to the individual energy storage modules, is complex and requires real-time communication and data transmission. This aspect is also omitted in the modular battery storage system described herein, so that the embodiments of the modular battery storage system can also be designed in a much simpler and more robust manner in this respect compared with conventional systems. In particular, errors in the PWM of the individual energy storage modules are excluded, which in conventional systems can lead to network faults, operational faults in the operation of the battery storage system itself and even hardware defects in the system.

Another particular advantage of carrying out the PWM at a central point in the separate modulation unit of the battery storage system is that optimum electromagnetic shielding is possible in the separate modulation unit, so that the PWM can be run at a very high frequency. This makes it possible to design the downstream filter choke, which is most effective at high frequencies, to be relatively small. This is particularly advantageous since, in general, the filter choke is, as its size increases, the most cost-intensive component of the system.

The modulation unit can be built very compactly, which further simplifies the shielding against electromagnetic interference radiation.

By avoiding high-frequency currents and voltages in the individual energy storage modules, electromagnetic compatibility is significantly improved compared with conventional systems, and the amount of shielding and filtering required is much lower than in conventional systems. The requirements for the cabling of the energy storage modules are also reduced; in particular, advantageously shielding for the signal lines can be dispensed.

Overall, in the modular battery storage system described herein, the individual energy storage modules can be designed much more simply than in conventional battery storage systems. The associated savings multiply with the number of individual energy storage modules. For example, the energy storage modules can be manufactured using conventional technology because no intelligence of the energy storage modules is required and because simple, inexpensive hardware and little software effort is required for the individual energy storage modules. In addition, less cooling effort is required in the individual energy storage modules and thus in the overall system. No complex and time-critical communication is required between the control device and the individual energy storage modules. For example, no data bus is required to control the individual energy storage modules. Overall, the battery storage system can thus be manufactured in a much more trouble-free and cost-effective manner.

Possible configurations of energy storage modules of battery storage systems are described in the outset. The configurations described are also preferred in the context of the modular battery storage system described herein. The energy storage elements can, for example, be aged energy storage elements with already reduced capacity that originate from other applications, e.g., automotive applications, and that can continue to be used expediently by being used in such a modular battery storage system.

Preferably, energy storage modules that can be used comprise electrochemical cells, in particular based on lithium-ion technology and/or based on nickel-metal hydride technology.

The energy storage modules comprised by the battery storage system can all have the same individual voltages U_{single}. However, by no means this needs always to be the case. On the contrary, it may even be preferable to install energy storage modules with different individual voltages U_{single} within the same system. This can elevate the representable variants of the total voltage U_{Total}.

The switches are preferably designed in such a way that the respectively assigned energy storage modules can also be activated with reversed polarity. This also increases the representable variants of the total voltage U_{Total}, in particular if energy storage modules with different individual voltages U_{single} are installed simultaneously within the same system. This is particularly advantageous because the individual voltage U_{single} of an energy storage module activated in reverse polarity makes a negative contribution to the total voltage U_{Total}.

If one of the n energy storage modules is deactivated, it does not contribute to the total voltage U_{Total}. In preferred embodiments, the switches are designed to be able to bypass the energy storage module belonging to them as required. Bridged deactivated energy storage modules are no longer electrically connected to the other energy storage modules of the array.

The modular battery storage system can comprise a very large number of energy storage modules. Generally, the variable n is a value in the range from 2 to 100000, preferably in the range from 2 to 10000, preferably 2 to 1000. Within these regions, it is further preferred that the variable n is a value in the range from 5 to 100, preferably from 5 to 20, preferably from 7 to 10.

In a preferred manner, the modular battery storage system has at least one of the immediately following additional features a. to c:
a. The modulation unit comprises a low-pass filter which is connected upstream of the pulse width modulation switch in the discharge direction.
b. The modulation unit comprises a low-pass filter connected downstream of the pulse width modulation switch in the discharge direction.
c. The housing also encloses the low-pass filter and/or the low-pass filter.

The low-pass filters, which in preferred embodiments are connected upstream and/or downstream of the pulse width modulation switch, can be conventional low-pass filters with which high-frequency components of the total voltage are attenuated up to a cutoff frequency in the region from 100 kHz to 1 GHz. Low-pass filtering before the introduction of the total voltage into the pulse width modulation switch has the particular advantage that the PWM in the pulse width modulation switch is less complex as a result of the reduced high-frequency components.

In a preferred manner, it is provided that, as an alternative or in addition to the upstream low-pass filter, a low-pass filter with the characteristic mentioned is also provided downstream of the filter choke. In a preferred manner, a low-pass filter is provided at the input of the modulation unit and another low-pass filter is provided at the output of the modulation unit.

The filter choke preferably differs from the low-pass filter(s) in that the filter choke is designed to smooth comparatively low-frequency components in the frequency range from 1 kHz to 10 MHz, especially with respect to the clock frequency of the converter and to low-scale harmonics.

Particularly suitable filter chokes preferably have a ferromagnetic core designed to be effective at the converter's clock frequency and low-scale harmonics. Suitable materials preferably have high permeabilities, so that the number of turns can be small and copper losses are kept within limits. Such cores, also known as “power ferrites,” are largely ineffective in the region from EMC-relevant higher frequencies, for example in the MHz range. Despite the fact that the copper winding is kept as small as possible due to the high permeability of the soft-magnetic core, the winding is nevertheless subject to relatively high, parasitic capacitances, which bridge the filter choke for high frequencies, as it were, and thus make it ineffective. Overall, the filter choke preferably filters the lower frequency components.

The preferably provided low-pass filter or filters can also be referred to as EMC filters, since they preferably filter out electromagnetic interference. Preferably, the low-pass filter or filters have a coil core with suitability for high frequencies. On the one hand, these materials generally have significantly lower permeabilities and saturation flux densities than the “power” materials mentioned, so that they have too little inductance for the fundamental frequency. On the other side, however, they are effective at the particularly EMC-relevant high frequencies. In particular, the low-pass filters are characterized by a low-capacitance winding. Due to the core material, they have a low inductance.

Preferably, the low-pass filter or filters also include smoothing or bleed capacitors. Furthermore, the low-pass filter(s) can also have an additional current-compensated choke and, if necessary, Y capacitors to combat common-mode interference. In this case, current-compensated chokes provide an inhibiting impedance to any common-mode interference that occurs. Y capacitors dissipate what is left to ground.

The design of the pulse width modulation switch as an H-bridge circuit with four semiconductor switches is in principle comparable with the basic electronic structure of a multilevel converter stage known per se. The voltage across the capacitor is advantageously adjusted or controlled by driving the power semiconductor devices by pulse width modulation. This has the particular advantage that the capacitor does not require a dedicated charging circuit.

In preferred embodiments of the modular battery storage system, the battery storage system has, with respect to the modulation unit, by one of the immediately following additional features a. and b:
a. The modulation unit comprises a cooling device.
b. A cooling device is assigned to the modulation unit.

The high-frequency currents, which in principle occur exclusively in the region from the modulation unit in the modular battery storage system, can lead to heat generation within the modulation unit, which is expediently countered by a cooling device for cooling the modulation unit. This cooling device can be arranged within the housing of the modulation unit or it can also be an external cooling device that is assigned to the modulation unit. For example, cooling circuits known per se or other cooling elements can be used for this purpose.

In a preferred manner, the modular battery storage system is characterized by at least one, preferably both, of the following additional features a. and b.:
a. The switches assigned to the n energy storage modules are not set up for pulse width modulation.
b. The n energy storage modules have no or only one passive cooling device or the n energy storage modules have no or only one passive cooling device.

The fact that the n energy storage modules of the battery storage system are not set up for pulse width modulation means that considerable savings can be made in the modular battery storage system described herein, since the energy storage modules can be very simply constructed and do not require any complex circuits. Since the pulse width modulation is performed at a central point in the modulation unit, no complex pulse width modulation switches are required on the individual energy storage modules. This has various advantages. In addition to the savings potential mentioned, there are also particular advantages with regard to heat generation in the modular battery storage system. By dispensing with pulse width modulation in the individual energy storage modules, no high-frequency currents are required in the regions and there is no need for elaborate cooling systems or cooling equipment, since there is no excessive heat generation in the energy storage modules. In preferred embodiments, low-cost cooling measures, such as enlarged copper areas on the printed circuit board and/or soldered SMD (surface mount device) heat sinks, are provided on the energy storage modules that are sufficient to compensate for the conduction losses that occur. In addition, cooling measures may be necessary or useful with regard to the ohmic losses during operation of the energy storage elements in the individual energy storage modules.

In a preferred manner, the modular battery storage system is, with regard to the control of the energy storage modules, characterized by the immediately following additional feature a.:
a. Signal lines are provided to control the switches assigned to the energy storage modules.

Since no pulse width modulation is provided for the individual energy storage modules and the pulse width modulation is performed exclusively at a central point in the modulation unit, the control of the individual energy storage modules can also be designed very simply. In particular, it is especially advantageous if only 0/1 signal lines are provided for controlling the switches assigned to the energy storage modules. For example, a comparatively slow, common bus system can be used to control the switches of the individual energy storage modules, since only one connection and disconnection of the individual energy storage modules is required. On the one hand, this embodiment of the control of the energy storage modules is in principle sufficient for the operation of the modular battery storage system and, on the other hand, enables a considerable cost-saving potential.

In preferred embodiments, optical fibers can be used for the 0/1 signal lines instead of conventional copper wires to improve immunity to interference. Optical fibers are somewhat more expensive than copper wires, but they already have inherent galvanic isolation and are not affected by electromagnetic interference in principle. Since generally no high clock rates are required for the system described herein, the necessary transmitters/receivers can be designed very simply and thus at low cost.

As an alternative to a 0/1 signal line, so-called tri-state elements can also be used. These are digital switching elements whose outputs can assume not only 0 and 1, but also a third, high-impedance state.

In a preferred embodiment of the modular battery storage system, the system always has the immediately following additional feature a:
a. The control device is configured such that at least two of the energy storage modules can be activated via the respectively assigned switches overlapping in time, but over activation periods of different lengths, in order to generate a total voltage U_{Total} (t) which changes over time.

The time-varying total voltage U_{Total} (t) can be generated with basically any voltage waveform. Thus, a sawtooth voltage can be generated in just as good an approximation as a triangular voltage.

Preferably, U_{Total} (t) is in particular a voltage with a sinusoidal voltage characteristic, as already mentioned in the outset. Thus, in preferred embodiments, the modular battery storage system can be operated in the form of a discharge process in which current from a DC voltage source is fed into an AC network with conversion of DC voltage into AC voltage.

In addition to the control of the energy storage modules, the modular battery storage system is, with regard to the functions of the control device, further characterized in a preferred manner by the immediately following additional feature:
a. The control device is configured to control the pulse width modulation switch in the modulation unit.

In this preferred embodiment, the control device thus takes over both the control and switching of the n energy storage modules and the control of the pulse width modulation switch in the modulation unit. For direct control of the pulse width modulation switch, a signal bus designed for high speeds is preferably provided. For the control of the n energy storage modules, the transmission of a simple 0/1 signal with low frequency is sufficient.

In preferred embodiments, the control device of the modular battery storage system always has one of the immediately following additional features below:
a. The control device is a signal processor.
b. The control device is a microcontroller.

The present disclosure further provides a method for operating a modular battery storage system according to the above description. In a preferred manner, this method comprises the immediately following steps a. and b.:
a. By successively activating and deactivating the n energy storage modules, a staircase voltage is generated, and
b. the staircase voltage is fed into the modulation unit and converted into a smoothed sinusoidal voltage by pulse width modulation and at least one filtering.

In a preferred manner, the smoothed sinusoidal voltage can be fed into an AC power grid as a phase. Thus, the DC voltage generated with the individual energy storage modules can be converted into an AC voltage by appropriate sequential control of the individual energy storage modules and used in corresponding power grids. Likewise, the system is also suitable for methods of operating multiphase systems, for example for generating a three-phase current.

In addition, the system can also be used to supply DC applications, such as charging electric cars or other. However, the system could also be used to both supply and draw DC voltage, for example from a photovoltaic system, without having to make any structural changes. The electricity stored in this way can be fed into a grid as alternating current or used as direct current, for example, to charge an electric vehicle.

It would thus be possible to design a system as a charging device, for example for electric vehicles, wherein the multilevel inverter of the system is designed to supply either DC voltage or AC voltage in a manner configurable via software. This means that a single charging device with a single power electronics system is able to serve different charging systems.

In principle, other arbitrary waveforms can also be generated when operating the modular battery storage system. For example, the modular battery storage system is also suitable for generating a DC voltage that can be used, for example, for photovoltaic system applications or for charging electric vehicles or for other purposes.

In a preferred manner, the method has the immediately following additional feature a:
a. The energy storage modules of the modular battery storage system are driven with a frequency between 50 and 500 Hz, preferably with 100 Hz.

A circuit with a frequency of 100 Hz is particularly advantageous, since this corresponds to the frequency of the half-waves in household grids, so that by means of such a circuit of the energy storage modules the generated AC voltage can be fed into a household grid as one phase without further ado.

In a preferred manner, the method further has the following additional features immediately below:
a. The pulse width modulation switch of the modulation unit is driven with a high frequency.

The high frequencies for driving the pulse width modulation switch are preferably in the region from 1 kHz to 1 Mhz. The actual frequency range selected is expediently adapted to the circuit technology and/or semiconductor technology used. In preferred embodiments, the frequency is in the region from 10 kHz to 200 kHz.

Due to the high frequencies used to control the pulse width modulation switch, the effectiveness of the downstream filter choke is particularly high, so that the filter choke can even be reduced in size at a high clock frequency for the pulse width modulation. The reduction in size of the filter choke thereby offers a particular savings potential in the embodiment of the modular battery storage system or in the embodiment of the modulation unit, so that a high clock frequency is preferred when driving the pulse width modulation switch. Due to the embodiment of the battery storage system and in particular due to the housing of the modulation unit, the electromagnetic interference emissions associated with high frequencies are not problematic, since a corresponding embodiment with shielding elements, for example by means of a metallic housing, is possible without great effort due to a compact design of the modulation unit.

In preferred embodiments, the housing is a metallic housing. However, it can also be provided that a metallized plastic is used for the housing or at least for shielding elements of the housing, i.e. the housing consists of plastic parts which have a metallic coating.

In preferred embodiments, the housing is designed for shielding in such a way that a Faraday cage is formed which encloses the power electronics essentially completely and does not form any slits or other openings that could form resonances or antennas at the frequencies that occur. Furthermore, metal grids covering ventilation openings can be provided as shielding measures, for example.

In preferred embodiments of the system, data communication to the individual energy storage modules is provided. Compared with conventional systems, however, a corresponding communication bus can be designed to be much simpler. In particular, no real-time capable data transmission is required, so that preferred data communication lines are not real-time capable. For example, low-cost interfaces such as CAN or RS485 can be used in this context.

In further preferred embodiments of the modular battery storage system or in preferred embodiments of the method for operating such a battery storage system, it may be provided that at least one performance parameter or at least one performance value is determined for each of the n energy storage modules. Depending on the determined performance parameter, activation periods of different lengths can be assigned to the individual energy storage modules. In other words, depending on the at least one performance parameter, an assignment is made as to which of the energy storage modules are activated for only a short period of time (a short activation period) and which of the energy storage modules are activated for a longer period of time (a longer activation period).

In general, the actual remaining capacity (State-of-Charge, in short: SOC) and the maximum available capacity (State-of-Health, in short: SOH) of the energy storage modules comprised by the battery storage system play a role in the operation of a battery storage system. A potential problem here is that the SOC and SOH of individual energy storage modules in a battery storage system can diverge greatly, for example as a result of different rates of aging. Generally, the energy storage modules with the worst performance values determine the overall performance of a battery storage system.

It is known that balancing systems can be used to equalize the charge and/or voltage between energy storage modules with unequal charge and/or voltage states. However, such balancing systems are not inexpensive to implement because the associated hardware and software costs are considerable.

In a preferred embodiment of the modular battery storage system or in a preferred embodiment of the method, unequal charge and/or voltage states can be compensated for by taking performance parameters into account when controlling the individual energy storage modules.

The performance value or performance parameter is a state value that is characteristic of the performance of an energy storage module. In particular, it can be the current SOC or the current SOH of the respective energy storage module at the time of determination. However, the at least one performance value can also be a value that correlates with the current SOC and/or the current SOH of the respective energy storage module.

Several known procedures exist for determining the SOC. For example, when a discharge voltage is measured, the current SOC value can be inferred using known discharge curves. However, in the context of the present disclosure, the method chosen for SOC determination is secondary. It is only important that the determined performance values are comparable with each other, i.e. obtained in a comparable manner, so that the performance of the energy storage modules can be compared on the basis of the values.

There are also several known procedures for determining the SOH. One characteristic of the SOH of an energy storage module is its internal resistance. For example, when an energy storage module is operated under defined conditions (temperature, state of charge, discharge current, discharge duration, etc.), a reference value for the internal resistance can be determined. Based on the change in internal resistance (measured under the same defined conditions), the SOH can be inferred. However, in the context of the present disclosure, the method chosen, if any, for SOC determination is also secondary. Again, it is only important that the determined performance values for the energy storage modules of the battery storage system are comparable with each other, i.e., obtained in a comparable manner, so that the performance of the energy storage modules can be compared with each other on the basis of the values obtained.

Generally, the SOH of an energy storage module—apart from formation cycles during its initial operation—does not change significantly between immediately successive charge and discharge cycles. If the at least one performance value is the current SOH or a value that correlates with the current SOH, it is therefore generally sufficient to determine the performance value only at intervals, for example at intervals of 10 charge and discharge cycles. The determined value can then be stored and used until it is updated when assigning the at least two energy storage modules to the activation periods of different lengths.

In contrast, it is generally expedient to determine the current SOC or, alternatively, to determine a value that correlates with the current SOH immediately prior to assignment, since the SOC can change to a significant extent at very short notice.

In preferred embodiments, the method has at least one of the following additional steps, particularly preferably all three of the following additional steps:

The determined performance values for each of the n energy storage modules are stored in a data memory, so that it is possible to sort the n energy storage modules according to their performance.

The energy storage modules are assigned to the activation periods of different lengths on the basis of the performance values stored in the data memory.

Energy storage modules with comparatively high performance are assigned longer activation periods than energy storage modules with comparatively low performance.

Generally, the activation periods correlate to the determined performance capabilities of the individual modules. For example, if the at least one performance value is the current SOH, the energy storage modules can be sorted by increasing SOH. The largest SOH value then indicates the highest performance capability, and the smallest SOH value indicates the lowest performance capability. It is preferred that the energy storage module with the largest SOH is assigned the longest activation period, while the energy storage module with the smallest SOH is assigned the shortest activation period.

As a result, more powerful energy storage modules are subjected to higher loads during operation than less powerful ones. As a result of the different loads, the performance capabilities of the energy storage modules are brought into line with each other again in the long term, since modules subjected to higher loads age more quickly on average than those subjected to lower loads. The method thus indirectly ensures symmetrization of the energy storage modules and thus has a similar effect to the balancing systems mentioned above.

Aged energy storage modules from electromobility have the greatest capacity variance. Such aged energy storage modules can also be operated together in a battery storage system without any problems according to the method described here, without having to be preselected. When an energy storage module has reached the end of its life, it can be easily replaced by a replacement module without the need for costly preparatory measures (matching, etc.). Even as-new energy storage modules can be connected and operated without any preparatory measures, regardless of their initial capacity and any production scatter.

Overall, these measures extend the useful life of the energy storage modules used in a battery storage system operated according to the present disclosure, which brings both an ecological and an economic advantage.

In preferred embodiments, the method has at least one of the following additional steps, preferably all five of the additional steps explained below:

The number m of energy storage modules required to generate a peak voltage U_{Ges} (t) is determined.

The m energy storage modules are selected from the available n energy storage modules.

In order to generate a desired voltage curve of U_{Ges} (t), the time intervals and the activation period over which the m energy storage modules are to be activated are specified.

Taking into account the sorting criteria “performance” and “length of activation periods assigned to them”, the selected m energy storage modules are sorted into an order in which the two sorting criteria either both increase or both decrease in the same direction.

The m energy storage modules can be sorted according to their capacity, the activation periods according to their length. The activation periods are assigned to the m energy storage modules. The assignment is made in such a way that, after the assignment, sorting the energy storage modules according to their capacity and according to the length of the activation periods assigned to them leads to the same result. Sorting according to increasing capacity thus results in an order in which the longest activation period is assigned to the most powerful module, the second longest activation period to the second most powerful, the third longest activation period to the third most powerful, and so on.

The m energy storage modules are activated in this order and at the specified time intervals.

The peak voltage is the largest amount of the instantaneous value of a periodically changing voltage. In the case of a sinusoidal voltage curve, the peak voltage corresponds to the amplitude of the sinusoidal oscillation.

In the simplest case (when all energy storage modules of the modular battery storage system have the same individual voltage U_{single}), m is determined by dividing the value of the peak voltage by the value of the individual voltage U_{single} supplied by an individual energy storage module.

In preferred embodiments, the modular battery storage system comprises more energy storage modules than are needed to generate the peak voltage. In brief, it is preferred that n>m. For example, the m energy storage modules may be selected based on available module performance data. For example, always the m most powerful modules can be selected.

With particular advantage, it can also be provided that defective energy storage modules are not taken into account in the selection. For this purpose, for example, a performance threshold value can be defined for each of the n energy storage modules, below which an energy storage module is deactivated.

If necessary, provision can be made for the deactivation to trigger a signal or message as a result of the undercut, indicating the deactivation and/or the need for replacement. The defective energy storage module can in principle be replaced during operation. The method does not have to be stopped for this purpose. For this purpose, the switches assigned to the energy storage modules have the above-mentioned option for bridging, in which the energy storage modules are no longer electrically connected to further energy storage modules.

In further preferred embodiments, the method has at least one of the following additional features and/or one of the following additional steps:

The desired voltage curve is sinusoidal.

The energy storage module with the highest capacity is activated first and the one with the lowest capacity last.

The energy storage module with the highest capacity is activated over the longest activation period and the energy storage module with the lowest capacity over the shortest activation period.

To generate a sine half-wave, it is expedient that the energy storage module to which the longest activation period has been assigned is activated first and deactivated last. On the other hand, the energy storage module to which the shortest activation period has been assigned should be activated last and deactivated first. Accordingly, the energy storage module that has been assigned the longest activation period has a comparatively high performance. The energy storage module to which the shortest activation period has been assigned, on the other hand, can exhibit comparatively low performance.

In further preferred embodiments, the battery storage system has at least one of the following additional features:

The array consisting of the n energy storage modules exclusively comprises energy storage modules of the lithium-ion type.

The array consisting of the n energy storage modules comprises exclusively energy storage modules of the nickel-metal hydride type.

The array consisting of the n energy storage modules comprises various types of energy storage modules.

The array consisting of the n energy storage modules comprises at least one energy storage module having a cathode based on LFP (lithium iron phosphate).

The array consisting of the n energy storage modules comprises at least one energy storage module having a cathode based on NMC (lithium nickel manganese cobalt oxide).

The array consisting of the n energy storage modules comprises at least one energy storage module having a cathode based on LTO (lithium titanate).

The array consisting of the n energy storage modules comprises at least one energy storage module having a cathode based on NCA (lithium nickel cobalt aluminum oxide).

The array of n energy storage modules comprises at least one Pb/PbO₂ type energy storage module.

In the modular battery storage system described herein, energy storage modules of various types can easily be interconnected. The strengths of individual types can be used in a targeted manner. Different energy storage modules can be driven according to requirements. For example, energy storage modules with a cathode based on LTO are suitable for absorbing high load peaks.

In principle, it is even possible to interconnect energy storage modules of the nickel-metal hydride type and energy storage modules of the lithium-ion type in a battery storage system.

Energy storage modules of the Pb/PbO₂ type are classically used with a sulfuric acid electrolyte as individual cells of a lead accumulator. Within the scope of the present disclosure, it may be preferred to interconnect the at least one energy storage module of the Pb/PbO₂ type with energy storage modules of the lithium-ion type in a battery storage system. Energy storage modules of the Pb/PbO₂ type are particularly suitable for use in vertexes.

In accordance with the foregoing, the battery storage system or method has at least one of the following features:

The energy storage modules of various types preferably have different individual voltages U_{single}.

Thus, for example, the array of n energy storage modules may comprise energy storage modules with a nominal voltage of 1.2 V (such as a nickel-metal hydride type energy storage module) combined with energy storage modules with a nominal voltage of 2 V (such as a Pb/PbO₂ type energy storage module).

The energy storage modules of various types preferably comprise an energy storage module selected from the group consisting of lithium-ion type energy storage modules, nickel-metal hydride type energy storage modules, and Pb/PbO₂ type energy storage modules.

The energy storage modules of various types preferably comprise at least two energy storage modules selected from the group consisting of lithium-ion type energy storage modules, nickel-metal hydride type energy storage modules, and Pb/PbO₂ type energy storage modules.

The array of n energy storage modules thus comprises, for example, at least one energy storage module of the nickel-metal hydride type with a nominal voltage of 1.2 V combined with at least one energy storage module of the Pb/PbO₂ type with a nominal voltage of 2 V or combined with at least one energy storage module of the lithium-ion type. Alternatively, the array of n energy storage modules can also have at least one energy storage module of each of the three types mentioned or at least one energy storage module of the Pb/PbO₂ type combined with at least one energy storage module of the lithium-ion type.

The energy storage modules of various types comprise at least one energy storage module selected from the group consisting of energy storage modules having a cathode based on LFP, energy storage modules having a cathode based on NMC, energy storage modules having a cathode based on LTO, and energy storage modules having a cathode based on NCA.

In preferred embodiments, the battery storage system is operated with a battery management system, wherein the individual modules are specifically controlled on the basis of measurable parameters of the energy storage cells or energy storage modules.

Further features and advantages of the invention will be apparent from the following description of working examples in conjunction with the drawings. In this connection, the individual features may each be realized separately or in combination with one another.

The basic operation of a modular battery storage system is described in detail, for example, in WO 2018/162122 A1, to which reference is hereby made.

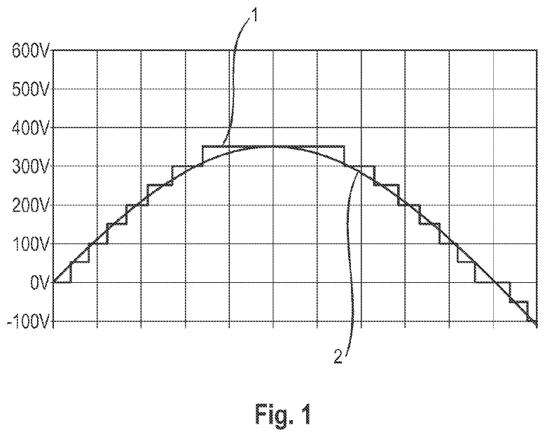

FIG. 1 illustrates the principle of smoothing or “wearing” a staircase voltage 1, which can be generated with a modular battery storage system, into a sinusoidal voltage 2, which can be used in particular for feeding into an AC grid. The staircase voltage is generated by successively switching on and off individual energy storage modules of a modular battery storage system, resulting in a total voltage in staircase-shaped gradation. This staircase voltage 1 is approximated to a sinusoidal voltage in a power grid. However, only a rough approximation to the desired output voltage is possible via the switching of the energy storage modules. It is therefore already known to perform a pulse width modulation (PWM) to approximate the staircase voltage 1 to the desired sinusoidal voltage 2, with which the voltage steps are cushioned or compensated.

The staircase voltage 1 is only an example of the possibilities of a modular battery storage system. In fact, any curve shapes can in principle be generated with the individual energy storage modules of a modular battery storage system.

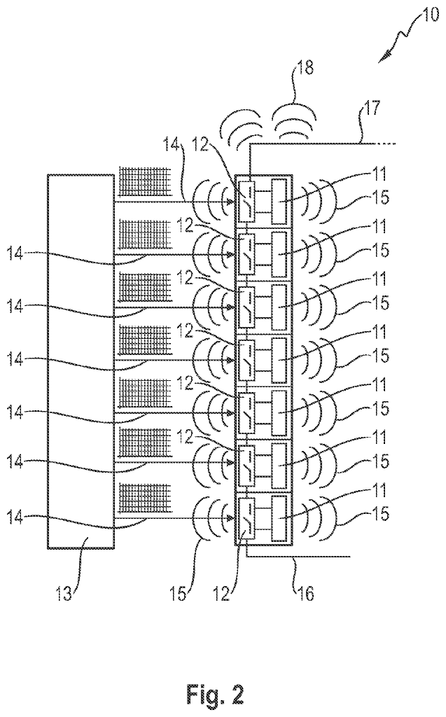

FIG. 2 illustrates a conventional modular battery storage system having a plurality of individual energy storage modules 11, each associated with a switch 12. The energy storage modules 11 are rechargeable energy storage modules. Each of the switches 12 is assigned exactly one energy storage module 11 and vice versa. By means of the switches 12, the respective energy storage modules 11 can be activated and deactivated.

Each of the switches 12 can have several switching positions. In a first switching position, the energy storage module 11 assigned to the switch 12 is activated and its individual voltage U_{single} is available. In a second switch position, the energy storage module 11 associated with the switch 12 is deactivated and its individual voltage U_{single} is not available. If necessary, a third switching position can be provided in which the energy storage module 11 assigned to the switch 12 is activated with reversed polarity.

All switches 12 are advantageously configured to be able to bridge the energy storage modules 11 associated to them in the event of deactivation. This means that deactivated energy storage modules 11 can be replaced during operation, for example.

The switches 12 are connected in series. The energy storage modules 11 can thus be connected via the switches 12 in such a way that the individual voltages U_{single} of activated energy storage modules 11 add up to a total voltage U_{Total}. If one of the switches 12 is in the second switching position, it bypasses the deactivated energy storage module 11 assigned to it. If one of the switches 12 is in the third switching position, the individual voltage U_{single} of the energy storage module 11 assigned to it makes a negative contribution to the total voltage U_{Total}. By appropriately activating the individual switches 12 via the control device 13, a staircase voltage can be generated by adding the individual voltages, which approximates a sinusoidal voltage curve. When the energy storage modules 11 are successively switched on, the total voltage U_{Total} increases in steps until the desired peak value is reached. The total voltage is then gradually reduced by successive deactivation of the individual energy storage modules.

In order to achieve a sufficient approximation to the sinusoidal curve of an alternating current, conventionally in the individual energy storage modules 11 the generated individual voltage is subjected to PWM via the respective associated switch 12 before the modulated individual voltages are combined. The modular battery storage system 10 has a neutral conductor 16 and an output 17, wherein the total voltage, which in particular approximates a sinusoidal voltage, can be fed into a mains voltage via the output conductor 17.

A high clock frequency is required for the PWM, so that the corresponding high-frequency activation 14 of the individual switches 12 results in the formation of electromagnetic interference radiation 15 in the region from the individual energy storage modules 11 and also in the region from the lines for activation 14 of the switches 12. The rapid switching operations at the switches 12 cause strong alternating magnetic fields at high currents, which can lead to the modular battery storage system hardly being usable in practice. In this case, the structure of the modular battery storage system 10 not only interferes with its own operation due to the electromagnetic interference emissions, but can also radiate considerable interference to the outside and magnetically couple into adjacent conductors. This necessitates extensive shielding against electromagnetic interference radiation in the entire region of the modular battery storage system 10. The output conductor 17 also causes electromagnetic interference emissions 18, which should be shielded.

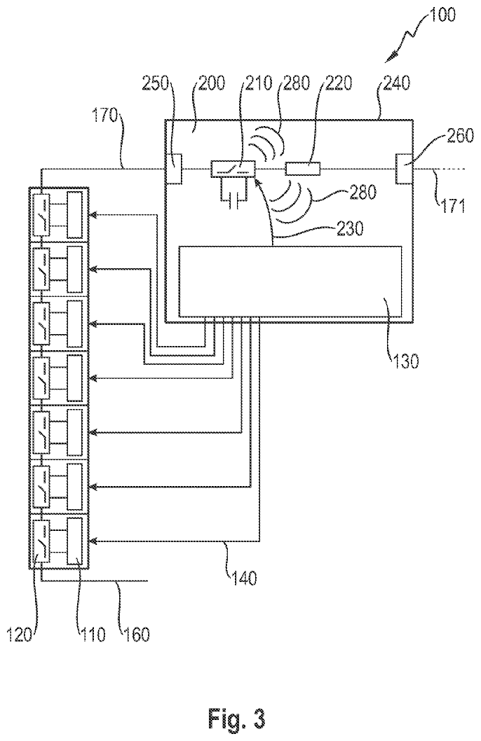

FIG. 3 illustrates a modular battery storage system 100. Here, too, a plurality of energy storage modules 110 are provided, each of which is assigned a switch 120. The neutral conductor 160 indicated in FIG. 3 is not mandatory. Thus, the system can also be designed as a three-phase system. In contrast to the conventional battery storage system explained with reference to FIG. 2, in each case a comparatively simple circuit 120 is provided, which primarily permits switching on and off of the individual energy storage modules 110 and which is controlled at a low frequency. The corresponding activation 140 via the control device 130 is therefore slow and can, for example, have a frequency of 100 Hz, which corresponds to the clock of mains half-waves. For example, simple 0/1 signal lines are sufficient here. A data bus is not required, or a very simply designed communication bus can be provided. In particular, no real-time capable lines are required. Due to the simple switches 120 and the simple signal lines 140, there is no relevant radiation of electromagnetic interference in the range from the individual energy storage modules 110, so that complex shielding measures can be dispensed with in this region.

The individual voltages U_{single}, which are generated in the individual connected or activated energy storage modules 110, are added to a total voltage U_{Total} and fed into a central modulation unit 200 via the output conductor 170. The core of the modulation unit 200 is a pulse width modulation switch 210, which performs the pulse width modulation of the voltage curve required for fine adjustment of the total voltage U_{Total}. Downstream of the pulse width modulation switch 210 is a filter choke 220, which provides further smoothing of the total voltage, which is chopped up to a certain extent by the pulse width modulation.

The clock frequency for the pulse width modulation, which is performed by direct control via a drive line 230 of the control device 130, is selected to be relatively high, since the filter choke 220 is then particularly effective and can accordingly be designed to be relatively small. Since the filter choke 220 is generally the most expensive component of the entire battery storage system 100, this measure offers considerable savings potential.

The electromagnetic interference emissions 280 arising in connection with the high-frequency pulse width modulations are effectively shielded by a housing 240 of the modulation unit 200, wherein the housing 240 or the modulation unit 200 is of particularly compact and robust design.

In preferred embodiments, a low-pass filter 250, 260 may be provided at the input and at the output of the modulation unit 200, respectively, to further smooth the overall voltage U_{Total}.

The resulting total voltage U_{Total} 171 after passing through the modulation unit 200 is particularly suitable, for example, to be fed into an AC network as one of, for example, three phases.

The control device 130 is preferably an integral part of the modulation unit 200, since this provides protection and shielding from the outside in a particularly suitable manner for the control device 130 as well.

The pulse width modulation switch 210 may be directly controlled by the control device 130 via the connection 230, wherein a high-speed data bus is not necessarily required for the connection 230.

The electromagnetic interference 280 caused by the high-frequency pulse width modulation switch 210 is reliably shielded by the housing 240. On the one hand, the compact and concentrated design of the modulation unit 200, which also integrates the filter choke 220, allows high switching frequencies and thus permits a reduction in the size and cost of the individual components. On the other side, in the battery storage system 100, the space-occupying structure of the individual energy storage modules 110 can be formed without further measures for shielding, which further reduces costs and simplifies the housing construction in the peripheral region of the battery storage system.

In preferred embodiments, the modulation unit 200 comprises a cooling device, which is not further illustrated herein.

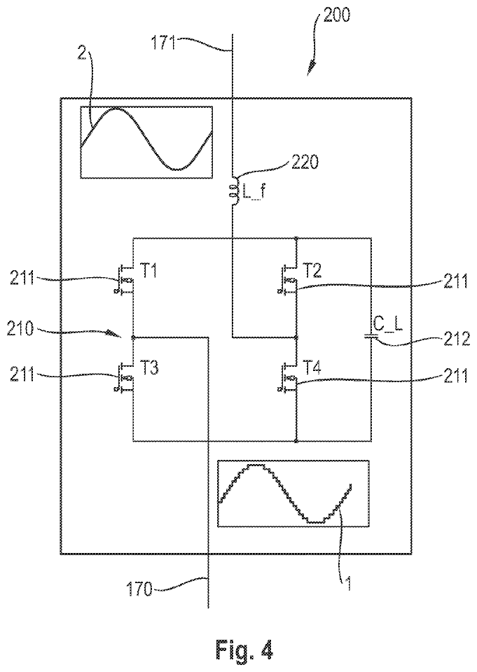

FIG. 4 illustrates the basic power electronic structure of the modulation unit 200. The pulse width modulation switch 210 comprises an H-bridge circuit with two line branches, each with two semiconductor switches (T1, T2 and T3, T4) connected (C_L) via a capacitor (212). The total voltage U_{Total} from the energy storage modules, which are not shown here, is fed into the input of the switch structure via their output conductor 170. In this example, the total voltage U_{Total} has the form of a staircase voltage 1.

The voltage applied to the capacitor 212 is adjusted or controlled by driving the power semiconductors 211, in particular by pulse width modulation. After passing through the circuit 210 and passing through the downstream filter reactor 220 (L_f), a smoothed sinusoidal voltage waveform 2 results, which can be fed into a mains voltage as one of the three mains phases, for example. However, such a sinusoidal shape of the resulting voltage is only one possible example of the voltage that can be generated with the modular battery storage system. Likewise, other waveforms or a direct current can also be generated.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1: A modular battery storage system comprising:
an array of n rechargeable energy storage modules, each respective rechargeable energy storage module of the n rechargeable energy storage modules comprising at least one rechargeable energy storage elements, each respective energy storage module being assigned a respective switch via which the respective energy storage module can be activated and deactivated, wherein the n rechargeable energy storage modules are configured to be interconnected, via the switches, such that a total voltage Uₜₒₜₐₗ; provided by the array of n rechargeable energy storage modules is a sum of respective individual voltages U_{single} of activated energy storage modules;
controller configured to control the switches; and
a modulator, connected to the n rechargeable energy storage modules and configured to modulate the total voltage U_{Total}, the modulator comprising:
a pulse width modulation switch, and
a housing that encloses the pulse width modulation switch and that is adapted to shield electronic components outside the housing from electromagnetic interference radiation emanating from the pulse width modulation switch.

2: The modular battery storage system of claim 1, wherein the pulse width modulation switch comprises at least one of:
a plurality of semiconductor switches,
H-bridge circuit with four semiconductor switches, and/or
an H-bridge circuit with four semiconductor switches and the H-bridge circuit comprises two line branches, each with two semiconductor switches connected via a capacitor.

3: The modular battery storage system of claim 1 wherein the modulator comprises a filter choke, and
wherein at the filter choke is connected downstream of the pulse width modulation switch in the discharge direction and/or the housing encloses the filter choke.

4: The modular battery storage system of claim 1, wherein the modulator comprises at least one of:
a low-pass filter connected upstream of the pulse width modulation switch in the discharge direction,
a low-pass filter connected downstream of the pulse width modulation switch in the discharge direction, and/or
a low-pass filter upstream or downstream of the pulse width modulation switch in the discharge direction, and wherein the housing also encloses the low-pass filter.

5: The modular battery storage system of claim 1, wherein the housing comprises metal and/or a metallized plastic.

6: The modular battery storage system according to claim 1,
wherein the modulator comprises a cooling device or
a cooling device is assigned to the modulator.

7: The modular battery storage system according to claim 1, wherein:
the switches are not set up for pulse width modulation, and/or
the n energy storage modules have no or only one passive cooling device, or the n energy storage modules have no or only one passive cooling device associated with them.

8: The modular battery storage system according to claim 1, further comprising signal lines configured to control the switches assigned to the n energy storage modules.

9: The modular battery storage system according to claim 1, wherein the controller is configured such that at least two of the energy storage modules can be activated, via respective assigned switches, over activation periods overlapping in time but of different lengths; in order to generate a time-varying total voltage U_{Total}.

10: The modular battery storage system according to claim 1, wherein the controller is configured to control the pulse width modulation switch in the modulator.

11: The modular battery storage system according to claim 1 wherein the controller is a signal processor or a microcontroller.

12: A method of operating the modular battery storage system according to claim 1, the method comprising:
successively activating and deactivating the n energy storage modules to generate a staircase voltage, and
feeding the staircase voltage into the modulator and—converting the staircase voltage into a smoothed sinusoidal voltage via pulse width modulation and at least one filtering process.

13: The method of claim 12, further comprising feeding the smoothed sinusoidal voltage into an AC power grid.

14: The method of claim 12, wherein the n rechargeable energy storage modules of the modular battery storage system are driven at a frequency between 50 and 500 Hz.

15: The method of claim 12, wherein the pulse width modulation switch of the modulator is driven at a high frequency in a range of 1 kHz to 1 Mhz.
